(19) United States
(12) Patent Application Publication
(10) Pub. No.: US 2019/0256399 A1
(43) Pub. Date: Aug. 22, 2019

(54) ADDITIVE LAYER PROCESS FOR MANUFACTURING GLASS ARTICLES FROM SOOT

(71) Applicant: Corning Incorporated, Corning, NY (US)

(72) Inventors: Sezhian Annamalai, Madison, AL (US); Thomas Richard Chapman, Painted Post, NY (US); Kenneth Edward Hrdina, Horseheads, NY (US); Douglas Hull Jennings, Corning, NY (US); Nicolas LeBlond, Painted Post, NY (US); Dale Robert Powers, Painted Post, NY (US)

(21) Appl. No.: 16/278,286

(22) Filed: Feb. 18, 2019

Related U.S. Application Data
(60) Provisional application No. 62/631,990, filed on Feb. 19, 2018.

(51) Int. Cl. C03B 37/012; C03C 13/04; C03B 19/06; C01B 33/18

(52) U.S. Cl. CPC C03B 37/01282; C03C 13/045; B33Y 10/00; C01B 33/18; C03B 19/066

(57) ABSTRACT

A process for manufacturing glass articles from powder at low temperatures includes the steps of preparing a slurry of powder suspended in a liquid; depositing the slurry on a substrate; drying the slurry to form a layer on the substrate; depositing slurry on the layer; drying the slurry deposited on the layer on the substrate to form another layer; repeating the steps of depositing a slurry and drying the to form a plurality of sequential layers on the substrate; and consolidating the plurality of sequential layers to form a glass article. The process requires a small manufacturing footprint, and facilitates the manufacture of very large near-net shape glass articles.

This application claims the benefit of priority to U.S. Provisional Application Ser. No. 62/631,990 filed on Feb. 19, 2018, the content of which is relied upon and incorporated herein by reference in its entirety.

### BACKGROUND OF THE DISCLOSURE

This disclosure relates to a method of manufacturing a glass article from silica powder, titania powder, or silica-titania powder. High purity silica-based articles are typically formed at high temperatures. It would be desirable to produce such articles at lower temperatures that do not require melting the material from which the articles are formed, thereby reducing energy costs and process equipment costs.

Silica powder pressing, molding and casting techniques have been developed to produce glass articles at moderate temperatures. Conventional silica powder pressing processes are described in the open literature (e.g., see United States Application Publication No. 2016/0251253). However, these techniques have presented challenges, including cracking and contamination that are not easily overcome. Gel casting also tends to require long drying times and produces drying cracks, limiting the maximum size of the articles that can be cast.

Improved lower temperature manufacturing techniques that overcome these problems and facilitate production of large, near-net shape ultra-low expansion articles, such as photomasks and mirrors for extreme ultraviolet lithography applications are desired.

### SUMMARY OF THE DISCLOSURE

A highly advantageous low temperature process for manufacturing glass articles from silica powder includes steps of preparing a slurry by mixing a silica-based powder and a liquid; depositing a coating of the slurry on a substrate; drying the coating; depositing an overcoating of the slurry on the layer of dried slurry; drying the overcoating deposited on the layer of dried slurry to form another layer of dried slurry; repeating the steps of depositing an overcoating and drying the overcoating for each of a plurality of sequential layers; and sintering the plurality of sequential layers to form the glass article.

The present disclosure extends to:

A process of manufacturing a glass article, comprising:
(a) depositing a slurry on a substrate, the slurry comprising a powder and a liquid, the powder comprising titania or silica-titania;
(b) drying the slurry to form a layer on the substrate; and
(c) repeating the depositing step (a) and the drying step (b) to form a porous powder body on the substrate, the porous powder body comprising a plurality of the layers.

The present disclosure extends to:

A process of manufacturing a glass article, comprising:
(a) depositing a coating of a slurry on a substrate, the slurry comprising a powder and a liquid, the powder comprising titania or silica-titania;
(b) drying the coating to form a layer of a porous powder body;
(c) depositing an overcoating of the slurry on the layer of the porous powder body;
(d) drying the overcoating to form another layer of the porous powder body; and
(e) repeating the steps of depositing an overcoating and drying the overcoating for each of a plurality of sequential layers of the porous powder body.

### BRIEF DESCRIPTION OF THE DRAWINGS

FIG. 1 is a graph illustrating the effect that addition of a base, such as ammonium hydroxide, has on the viscosity of a silica powder slurry as a function of solid loading (wt %).

FIG. 2 is a schematic illustration of a conventional apparatus for flame deposition of dry silica powder.

FIG. 3 is a schematic illustration of a modified form of the conventional flame deposition apparatus that is suitable for an additive manufacturing process.

### DESCRIPTION OF THE DETAILED EMBODIMENTS

The invention is an additive manufacturing process to build large, homogeneous, monolithic structures (like would be done in 3D printing or solid freeform fabrication) via layer-by-layer deposition and drying of a slurry to form a porous powder body followed by consolidation of the porous powder body to form a glass article.

The slurry includes a powder and a liquid. The powder is preferably dispersed or suspended in the liquid. As used herein, the term “powder” refers to particles having an average diameter less than 200 nm. Preferred powders have an average particle diameter in the range from 50 nm-150 nm, or in the range from 60 nm-140 nm, or in the range from 70 nm-130 nm, or in the range from 80 nm-120 nm. The powder can be produced by a variety of methods including flame oxidation or hydrolysis of one or more powder precursor compounds. Preferred powders are silica powders, mixtures of silica powder and metal oxide powder (e.g. a mixture silica powder and titania powder), and mixed silica-metal oxide powders (e.g. silica-titania powders). An example of silica powder is fumed silica. Water is a preferred liquid for the slurry. The amount of powder in the slurry is referred to herein as “solids loading” and is expressed in terms of the percent by weight of powder in the liquid (wt %).

In the additive manufacturing process, a slurry is deposited on a substrate and dried. Slurry deposition and drying are repeated to form a porous powder body. Each cycle of slurry deposition and drying forms a layer of the porous powder body. Slurry deposition occurs by applying the slurry to a substrate or to previous layers deposited on the substrate. Processes for applying the slurry include spraying, coating, and dipping. As used herein, “drying” refers to removal of at least 10% (weight basis) of the liquid from the slurry, most (e.g., greater than 50%) of the liquid from the slurry, or essentially all of the liquid (e.g., greater than 80%, 90%, 95% or 99% by weight) of the liquid from the slurry.

Substrates include glasses and ceramics. Preferred substrates include glasses with low thermal expansion, including titania-silica glasses.

The product formed from two or more cycles of slurry deposition and drying is referred to herein as a porous powder body. The porous powder body includes two or more layers, where each layer is the product of one cycle of slurry deposition and drying. The porous powder body is a pre-consolidated body. Consolidation of the porous powder body leads to densification and closure of pores. The product of consolidation is referred to herein as a glass article.

The thickness of the porous powder body can be increased and controlled in the additive manufacturing process with multiple cycles of slurry deposition and drying. The additive manufacturing process is analogous to outside vapor deposition (OVD) laydown except that it employs a slurry as a source of powder instead of a hot powder aerosol as is produced by a flame from a vapor phase powder precursor in the OVD process. Similar slurry deposition processes occur in nature as in the growth of a stalagmite or stalactite where mineral-laden water is evaporated from a dripping surface over time to grow a large structure. Similar processes are used in the manufacture of shell molds for investment casting of metal articles.

When sufficient layers have been applied in the additive manufacturing process to achieve a porous powder body with a desired thickness, the porous powder body is consolidated by heating to form a glass article. The temperature of consolidation is 800° C. or greater, or 900° C. or greater, or 1000° C. or greater, or 1100° C. or greater, or a temperature in the range from 800° C.-1500° C., or a temperature in the range from 1000° C.-1500° C., or a temperature in the range from 1200° C.-1500° C. Consolidation induces closure of the pores of the porous powder body and densification of the porous powder body. The density of the glass article is at least 10% greater than the density of the porous powder body, or at least 20% greater than the density of the porous powder body, or at least 30% greater than the density of the porous powder body, or at least 40% greater than the density of the porous powder body, or in the range from 30%-90% greater than the density of the porous powder body, or in the range from 40%-80% greater than the density of the porous powder body.

The additive manufacturing process offers several advantages over dry powder processing when forming glass articles. First, slurries provide higher powder density before consolidation than do techniques that use dry powder. The density of dry silica powder, for example, is only about 0.1 g/cc to about 0.2 g/cc. The density of dry silica powder can be increased to about 0.7 g/cc to about 1.0 g/cc through compaction, but extreme force is required (e.g. 30,000 psi) due to an approximately exponential increase in compaction force as the density of the porous powder body increases. The density of a porous powder body formed from a silica slurry in the additive manufacturing process described herein is about 1.2 g/cc to about 1.3 g/cc, or in the range from 1.0 g/cc-1.4 g/cc, or in the range from 1.1 g/cc-1.8 g/cc, or in the range from 1.2 g/cc-1.7 g/cc, or in the range from 1.3 g/cc-1.6 g/cc. As used herein, density of a porous powder body refers to the density of the porous powder body in a dry state. For purposes of determining density, a dry state refers to a state in which at least 99% by weight of the liquid of the slurry has been removed.

The density of the porous powder body before consolidation has important implications on the size of the manufacturing footprint. The low density of dry silica powder, for example, means that more floor space is needed to store dry silica powder. The volume of dry silica powder needed to form a 100 kg porous powder body is about 1 m³. The volume required to store a corresponding amount of silica slurry is far less. The size of the consolidation furnace needed to densify a porous powder body to form a glass article is also reduced significantly when using a silica slurry instead of dry silica powder due to the higher density of porous powder bodies made from a silica slurry relative to dry silica powder. The higher porous powder body density provided by the additive manufacturing process also reduces shrinkage of the porous powder body during consolidation, which improves near net shape dimensional uniformity. Analogous advantages occur with slurries based on metal oxide powder, combinations of silica powders and metal oxide powders, and mixed silica-metal oxide powders.

Second, use of slurries enables fine-scale mixing of powders, which leads to greater compositional homogeneity and more precise control of composition. The fine-scale mixing is a consequence of the fluid nature of slurries. Relative to dry powders, slurries permit more intimate mixing of powder constituents and greater uniformity of composition. For example, when it is desired to modify the composition of silica with a dopant, the dopant can be added to a silica slurry in the form of a solid. The dopant becomes uniformly suspended or distributed in the silica slurry and a doped silica with high compositional homogeneity can be produced. It is far more difficult to dope dry silica powder. Preferred dopants include metals and metal oxides.

The improved compositional uniformity available from slurries in the additive manufacturing process extends to mixed oxide compositions. An important mixed oxide composition of silica is silica-titania. Silica-titania glasses within certain compositional ranges (e.g. 5 wt %-9 wt % titania) have exceptionally low coefficients of thermal expansion. An important application of silica-titania glasses is as substrates for optics in EUV (extreme ultraviolet) lithography. In addition to a low coefficient of thermal expansion, the zero crossover temperature (T_{ZC}) (the temperature at which the coefficient of thermal expansion is zero) is an important consideration in EUV lithography. The zero crossover temperature is highly sensitive to the titania concentration and high uniformity of titania over the dimensions of a silica-titania substrate is needed to meet the specifications required for EUV lithography.

The conventional process used to make silica-titania glass substrates for EUV lithography utilizes a burner to co-combust a vapor phase silica precursor and a vapor phase titania precursor. The combustion produces silica-titania particles that are deposited on a surface to form a porous silica-titania body that consolidates to a densified state to form a glass article. The compositional uniformity available from the combustion process, however, is limited due to inherent variability in the titania content of the silica-titania particles and the intimate mixing of dry silica-titania particles needed to homogenize titania content is slow, cumbersome, and susceptible to contamination.

The intimate mixing needed for compositional uniformity is readily achieved in a slurry-based process. A silica-titania slurry can be formed from silica-titania particles, by combining a silica slurry and a titania slurry, by adding titania powder to a silica slurry, or by adding silica powder to a titania slurry. In each instance, the slurry phase permits intimate mixing and high compositional uniformity. Precise control of the absolute titania concentration is also possible. If, for example, the titania concentration of a glass article prepared by an additive manufacturing process is too high to achieve a desired zero crossover temperature, the additive manufacturing process can be repeated by diluting the initial silica-titania slurry with a silica slurry. Similarly, if the titania concentration is too low, the additive manufacturing process can be repeated by diluting the initial slurry with a titania slurry. The ability to accurately control the relative proportions of silica slurry, titania slurry, and silica-titania slurry provides fine control over the absolute titania concentration and the intimate mixing available from the slurry phase provides high uniformity of titania concentration.

Third, higher purity is available from the additive manufacturing process because slurries can be passed through much finer mesh filters than dry powders to remove contaminants. Buoyancy effects in the slurry also permit segregation by gravity of silica, titania, and/or silica-titania particles of different size. The fraction having a desired particle size can be recovered and used in the additive manufacturing process.

Layer-by-layer formation of porous powder bodies offers several advantages. Near-net shape manufacturing of large objects is possible. The capital investment required for slurry preparation and drying equipment is minimal compared to the equipment needed for methods for forming large objects from dry powders (e.g. pressing/molding). Stable aqueous slurries with high silica loading are achievable by increasing the ionic strength of the slurry. One way to increase the ionic strength of the slurry is to increase the pH of the slurry. High loading of aqueous slurries with silica can be achieved at neutral pH or higher (e.g., about pH 7-pH 11) by adding an ionic base. Silica slurries with high silica loading are advantageous because upon, strong bonds and rigid aggregates form due to preferential precipitation of silica at particle necks, where neck refers to a solid or liquid bridge between particles. Such conditions are typically avoided in the processing of dry silica powder because rigid aggregates are highly resistant to pressing forces and limit the degree of densification possible through compaction. Since the porous powder body formed in the additive manufacturing process requires no compaction and is formed directly in a state compatible with consolidation, strong bonds and rigid aggregates are advantageous because strongly bonded layers are resistant to hydration and swelling. This enables the formation of multilayer silica bodies without cracks. Similar advantages occur in slurries that include combinations of silica powder and metal oxide powder, or mixed silica-metal oxide powders.

Minimization of cracks is also facilitated by the alternating nature of the deposition and drying steps used in the additive manufacturing process. Since drying occurs after deposition of each layer and because each layer is thin, significant removal of liquid from each layer occurs. Low liquid retention in the porous powder body mitigates crack formation by minimizing stresses that arise as internal liquid evaporates during consolidation.

Cracking can also be mitigated by incorporating a plasticizer in the slurry or by allowing shrinkage that occurs during drying to take place without resistance. For example, the substrate onto which the slurry is deposited can be configured to shrink with the porous powder body as it dries or to provide low enough friction to avoid creation of stress on the porous powder body as it shrinks. One substrate material with a low coefficient of friction is PTFE (polytetrafluoroethylene) lined with PTFE film

In the additive manufacturing of silica, a slurry is prepared from silica powder and a liquid medium (e.g. water). The silica powder is a solid and the silica slurry preferably includes a high solids loading (e.g., 50% or greater, or 60% or greater, or 70% or greater by weight). In order to increase loading of silica powder in water, the pH of the slurry is increased (e.g., to a pH of 7 or greater, or 8 or greater, or 9 or greater, or in the range from 7-12, or in the range from 8-11) through the addition of a base. Preferably, the base does not contain a metal cation or contribute metal cation impurities. A preferred base is ammonium hydroxide, which may be present in the slurry at a concentration greater than 0.1 mol/liter, or greater than 0.5 mol/liter, or greater than 1.0 mol/liter or greater than 2.5 mole/liter, or greater than 5.0 mol/liter, or greater than 7.5 mol/liter or in the range from 0.1 mol/liter to 10 mole per liter, or in the range from 0.2 mol/liter to 9.0 mol/liter, or in the range from 0.5 mol/liter to 8.0 mol/liter, or in the range from 1.0 mol/liter to 7.0 mol/liter. At a fixed loading of silica powder, addition of a base to the slurry reduces viscosity (e.g., less than 100, 75 or 50 cps (centipoise)).

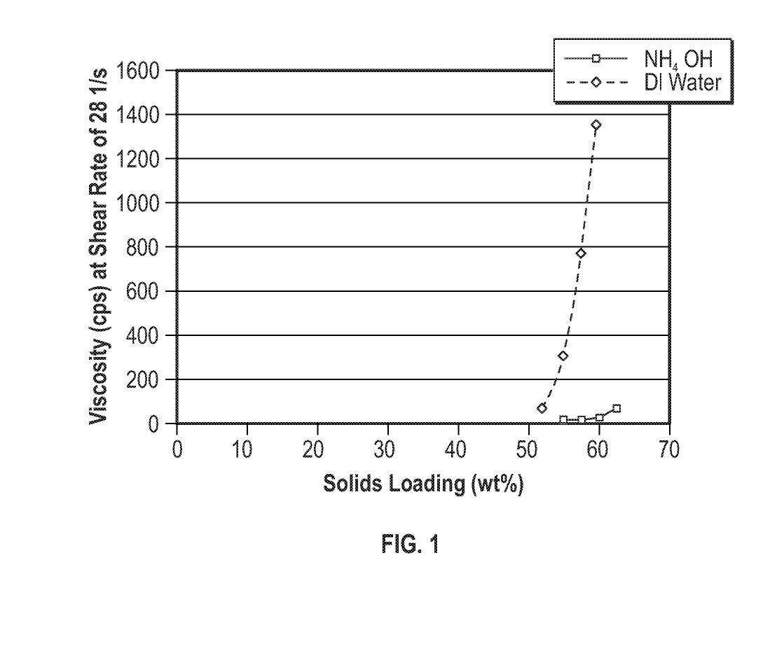

FIG. 1 shows the variation in slurry viscosity as a function of solids (silica powder) loading for slurries with and without ammonium hydroxide (NH₄OH). The viscosity is the shear viscosity of the slurry measured at a shear rate of 28 s⁻¹. Slurries were prepared by adding silica powder to deionized water (DI water) at loadings between about 52 wt % and 63 wt %, where wt % refers to percent by weight. Diamond symbols show viscosity for slurries without ammonium hydroxide and indicate that the viscosity increases significantly with solids loading in slurries without a base. Square symbols show viscosity for slurries that included 2 M (2 moles/liter) of ammonium hydroxide. Inclusion of a base leads to a pronounced reduction in slurry viscosity. Low slurry viscosity facilitates processing of the slurry and promotes greater uniformity in coverage when applying layers to the substrate or on top of other layers.

A slurry with low viscosity and high solids loading is preferred for the additive manufacturing process. In the additive manufacturing process described herein, the slurry has a shear viscosity at a shear rate of 28 s⁻¹ less than 200 centipoise and a solids loading of 55 wt % or greater, or a solids loading of 60 wt % or greater; or a shear viscosity at a shear rate of 28 s⁻¹ less than 150 centipoise and a solids loading of 55 wt % or greater, or a solids loading of 60 wt % or greater; or a shear viscosity at a shear rate of 28 s⁻¹ less than 100 centipoise and a solids loading of 55 wt % or greater, or a solids loading of 60 wt % or greater.

Increased slurry pH also increases silica solubility, increases silica dispersion, and promotes precipitation of silica at particle necks during drying to increase the density and strength of the porous silica powder body. The density and strength of the porous silica powder body can be controlled over a wide range in aqueous slurries by controlling pH. Porous silica powder bodies with higher density and higher strength are formed upon drying when the pH of the aqueous silica slurry is high. The density and strength can be reduced by decreasing the pH of the aqueous silica slurry or by forming the silica slurry in a non-aqueous liquid medium. It is also possible to tailor the solubility of silica powder in the slurry using pH or to minimize the solubility of silica powder using non-aqueous solvents to minimize or manipulate dried density. Soot porous powder bodies with low density are more porous and are advantageous for doping with vapor phase precursors (e.g. doping with fluorine or chlorine). Control of density and strength may also be desired to control stresses and striations in composition or density that may arise in the formation of multiple layers in the additive manufacturing process.

An aqueous silica slurry with high solids content can be achieved at lower pH if a dispersant is added to the slurry to increase the ionic strength of the slurry. For example, inclusion of ammonium citrate (an ionic dispersant) was shown to produce stable silica slurries with 60-70% solids loading suspensions at neutral pH. The ionic strength of the slurry can also be increased by adding an acid (e.g. citric acid or HCl) to the slurry to achieve an aqueous silica slurry with high solids content at low pH.

The slurry can be deposited on a substrate using spraying or dip coating techniques. In one method, a substrate is dunked into a slurry, removed, and dried to form a layer of the porous powder body. Drying can be accomplished by evaporation, hot air convection, heating, and/or radiation (e.g. infrared or microwave frequencies). Drying is accomplished at temperatures below 200° C. Preferred drying temperatures are in the range from 20° C.-100° C., or in the range from 30° C.-90° C., or in the range from 40° C.-80° C. Drying is accompanied by shrinkage in a linear dimension of the porous powder body of less than 10%, or less than 7.5% or less than 5.0% or less than 2.5%, or in the range from 0.5%-7.5%, or in the range from 1.5%-5.0%, or in the range from 2.0%-4.0%. The sequence of steps is repeated to form a porous powder body having a targeted thickness. The shape of the porous powder body or glass article formed therefrom can be facilitated by the geometry selected for the substrate. For a round or cylindrical porous powder body (e.g. an optical fiber preform), a substrate such as a rod is preferred. For the case of a planar porous powder body (e.g. a blank for a mirror or photomask used in EUV lithography made from a slurry with silica-titania powder), a substrate with planar geometry is preferred. Depending on the application, the porous powder body may or may not be removed from the substrate. For example, in the case of an EUV mirror, it may be advantageous to use a substrate having thermal expansion properties matched to the layers formed by depositing and drying a slurry and for the substrate to remain as an integral component of the glass article formed by consolidation. The glass article can then be polished to provide an excellent mirror surface.

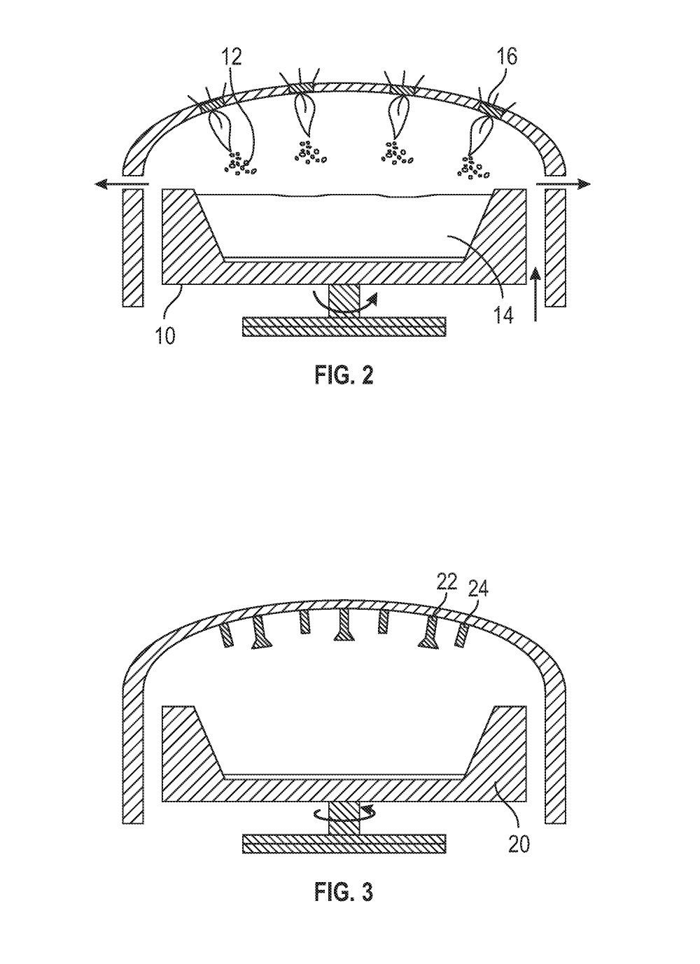

A second method for making glass articles from a slurry in an additive manufacturing process employs a modification of an apparatus conventionally used for direct laydown of silica powder. The conventional apparatus is shown in FIG. 2. In the conventional apparatus, a cup 10 rotates and oscillates while silica or other powder 12 is flame deposited onto a surface to form a boule 14. A modified version of this apparatus for slurries (FIG. 3) also utilizes a cup 20 that rotates and oscillates, but replaces burners 16 (FIG. 2) with slurry sprayers 22 and dryers 24 (FIG. 3). The apparatus can alternate between spraying and drying processes or can perform both processes simultaneously. For example, the two processes can be performed out of phase rotationally and/or temporally. The drying process can occur by evaporation, hot air convection and/or radiation. In the conventional apparatus, the furnace crown is removable. With a removable crown in slurry deposition, it is possible to use different crowns for the slurry deposition and drying cycles, and the consolidation process. The crown used for slurry spraying and drying need not be constructed of materials that can withstand high processing temperature. A conventional crown with burners can then be used to consolidate the porous powder body to form a glass article. In consolidation, the burners combust fuel to provide the heat needed for consolidation, but would not combust powder precursors.

The advantages of the additive manufacturing process over direct laydown of dry powder are (1) the ability to dope the porous powder body formed in the additive manufacturing process via gas phase infiltration (for example, the refractive index of a porous silica powder body can be varied through doping with chlorine or fluorine, and the slope of the coefficient of thermal expansion of porous silica-titania powder bodies can be reduced by doping with fluorine), and (2) the elimination of composition striae (i.e., spatially short range variations of the homogeneity of the refractive index of the glass). Striae may still exist in silica-titania glass articles formed by the additive manufacturing process in the form of layers that differ in density, but the segregation of silica from titania does not occur in the additive manufacturing process as it does for thermophoretic (e.g. flame) deposition of silica-titania powder in the conventional apparatus.

As a final step, the porous powder body can be thermally consolidated via a viscous sintering step either with or without doping. The process for consolidating large porous glass articles is well known and includes thermal treatment at the temperatures described above. Consolidation is accompanied by shrinkage of a linear dimension of the porous powder body of greater than 10%, or greater than 15%, or greater than 20%, or in the range from 10%-30%, or in the range from 15%-25%.

Layer-by-layer processes have been proposed where powder is laid down and sintered. The additive manufacturing method described herein is different because it enables realization of the processing benefits of fluid slurries.

Clause 1 of the present disclosure extends to:

A process of manufacturing a glass article, comprising:

(a) depositing a slurry on a substrate, the slurry comprising a powder and a liquid, the powder comprising titania or silica-titania;

(b) drying the slurry to form a layer on the substrate; and

(c) repeating the depositing step (a) and the drying step (b) to form a porous powder body on the substrate, the porous powder body comprising a plurality of the layers.

Clause 2 of the present disclosure extends to:

The process of Clause 1, wherein the slurry comprises 50% by weight or greater of the powder.

Clause 3 of the present disclosure extends to:

The process of Clause 1 or 2, wherein the slurry has a shear viscosity less than 100 centipoise when measured at a shear rate of 28 s⁻¹.

Clause 4 of the present disclosure extends to:

The process of Clause 3, wherein the slurry comprises 60 wt % or greater of the powder.

Clause 5 of the present disclosure extends to:

The process of any of Clauses 1-4, wherein the slurry further comprises a dispersant.

Clause 6 of the present disclosure extends to:

The process of Clause 5, wherein the dispersant is ammonium citrate.

Clause 7 of the present disclosure extends to:

The process of any of Clauses 1-6, wherein the slurry further comprises a plasticizer.

Clause 8 of the present disclosure extends to:

The process of any of Clauses 1-7, wherein the substrate is PTFE.

Clause 9 of the present disclosure extends to:

The process of any of Clauses 1-8, wherein the powder further comprises silica.

Clause 10 of the present disclosure extends to:

The process of any of Clauses 1-9, wherein the liquid comprises water.

Clause 11 of the present disclosure extends to:

The process of Clause 10, wherein the liquid has a pH greater than 7.

Clause 12 of the present disclosure extends to:

The process of Clause 10, wherein the liquid has a pH greater than 9.

Clause 13 of the present disclosure extends to:

The process of Clause 10, wherein the liquid further comprises a base.

Clause 14 of the present disclosure extends to:

The process of Clause 13, wherein the base comprises an organic cation.

Clause 15 of the present disclosure extends to:

The process of Clause 13, wherein the base is ammonium hydroxide.

Clause 16 of the present disclosure extends to:

The process of Clause 15, wherein the ammonium hydroxide is present in the liquid at a concentration greater than or equal to 1 mole per liter.

Clause 17 of the present disclosure extends to:

The process of any of Clauses 1-16, wherein the slurry is deposited using a dip coating technique.

Clause 18 of the present disclosure extends to:

The process of any of Clauses 1-16, wherein the slurry is deposited using a spraying technique.

Clause 19 of the present disclosure extends to:

The process of any of Clauses 1-18, wherein the steps of depositing and drying are performed simultaneously on different regions of the porous powder body.

Clause 20 of the present disclosure extends to:

The process of any of Clauses 1-19, wherein the porous powder body has a density in the range from 1.0 g/cc-1.4 g/cc.

Clause 21 of the present disclosure extends to:

The process of any of Clauses 1-20, further comprising doping the porous powder body.

Clause 22 of the present disclosure extends to:

The process of Clause 21, wherein the doping is accomplished by gas infiltration.

Clause 23 of the present disclosure extends to:

The process of Clause 21, wherein the doping comprises doping the porous powder body with fluorine or chlorine.

Clause 24 of the present disclosure extends to:

The process of any of Clauses 1-23, further comprising consolidating the porous powder body to form a glass article.

Clause 25 of the present disclosure extends to:

The process of Clause 24, wherein the glass article has a density that is at least 20% greater than the density of the porous powder body.

Clause 26 of the present disclosure extends to:

The process of any of clauses 1-25, wherein the substrate is a glass or ceramic.

Clause 27 of the present disclosure extends to:

The process of clause 26, wherein the substrate is a titania-silica glass

The described embodiments are preferred and/or illustrated, but are not limiting. Various modifications are considered within the purview and scope of the appended claims.

What is claimed is:

1. A process of manufacturing a glass article, comprising:
(a) depositing a slurry on a substrate, the slurry comprising a powder and a liquid, the powder comprising titania or silica-titania;
(b) drying the slurry to form a layer on the substrate; and
(c) repeating the depositing step (a) and the drying step (b) to form a porous powder body on the substrate, the porous powder body comprising a plurality of the layers.

2. The process of claim 1, wherein the slurry has a shear viscosity less than 100 centipoise when measured at a shear rate of 28 s⁻¹.

3. The process of claim 2, wherein the slurry comprises 60 wt % or greater of the powder.

4. The process of claim 1, wherein the slurry further comprises a dispersant.

5. The process of claim 4, wherein the dispersant is ammonium citrate.

6. The process of claim 1, wherein the slurry further comprises a plasticizer.

7. The process of claim 1, wherein the substrate is PTFE.

8. The process of claim 1, wherein the powder further comprises silica.

9. The process of claim 1, wherein the liquid comprises water.

10. The process of claim 9, wherein the liquid has a pH greater than 9.

11. The process of claim 9, wherein the liquid further comprises a base.

12. The process of claim 11, wherein the base comprises an organic cation.

13. The process of claim 1, wherein the slurry is deposited using a dip coating technique.

14. The process of claim 1, wherein the slurry is deposited using a spraying technique.

15. The process of claim 1, wherein the steps of depositing and drying are performed simultaneously on different regions of the porous powder body.

16. The process of claim 1, wherein the porous powder body has a density in the range from 1.0 g/cc-1.4 g/cc.

17. The process of claim 1, further comprising doping the porous powder body.

18. The process of claim 17, wherein the doping comprises doping the porous powder body with fluorine or chlorine.

19. The process of claim 1, further comprising consolidating the porous powder body to form a glass article.

20. The process of claim 19, wherein the glass article has a density that is at least 20% greater than the density of the porous powder body.

21. The process of claim 1, wherein the substrate is a titania-silica glass.
